(19) United States
(12) Patent Application Publication
(10) Pub. No.: US 2008/0073631 A1
(43) Pub. Date: Mar. 27, 2008

(54) Quik catch

(76) Inventor: Weixiong Huo, Las Vegas, NV (US)

Correspondence Address: Weixiong Huo, 7497 Coral River Dr, Las Vegas, NV, 89131, US

(21) Appl. No.: 11/729,385

(22) Filed: Mar. 29, 2007

Related U.S. Application Data
(60) Provisional application No. 60/797,043, filed on Sep. 21, 2006.

(51) Int. Cl. H02G 1/08

(52) U.S. Cl. 254/134.3 FT

(57) ABSTRACT

The current electrical fishing-tape or similar tools are only designed for pulling electrical wires or cable through electrical conduit. But this invention is designed to attach an end of leader or fishing tape to enable it to be hooked and retrieved from each opposite end of an electrical conduit by another fishing tape making it easy to attach to the other.

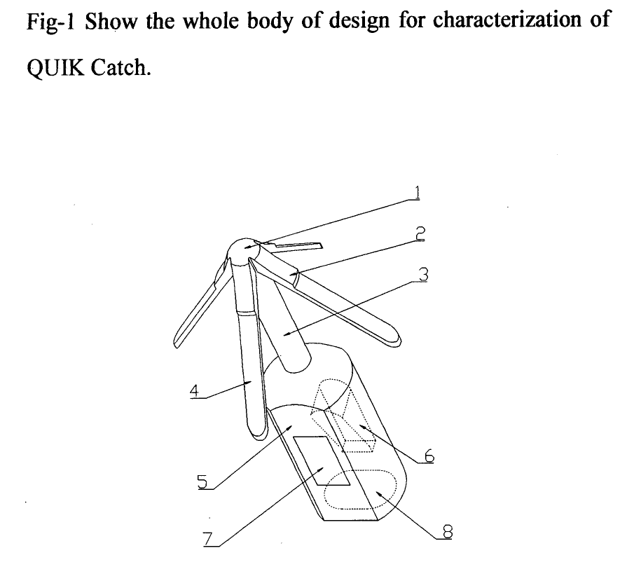

Since certain changes may be made in the foregoing disclosure without departing from the scope of the invention herein involved, it is intended that all matter contained in the above description and depicted in the accompanying drawings be construed in an illustrative and not in a limiting sense.

### CROSS-REFERENCE TO THE RELATED APPLICATION

not applicable

### FEDERALLY SPONSORED RESEARCH

not applicable

### SEQUENCE LISTING OR PROGRAM

not applicable

### BACKGROUND OF THE INVENTION WHICH FIELD OF INVENTION

The purpose of the invention is to retrieve a stuck or jammed electrical fishing tape or similar tool in an existing electrical conduit.

### BACKGROUND OF INVENTION

When pulling wire, a fish-tape must be run through the conduit first but sometime the fish-tape gets stuck in the electrical pipe, in that case, the electrician must attach a piece of wire to try to retrieve the fish-tape in the pipe, eventually even cat or remove the pipe and fittings, it can waste too much time. This invention is much easier to retrieve and catch the fish tape or similar tool which is stuck in the electrical pipe.

### DRAWINGS—REFERENCE NUMERALS

#1. A head of the QUIK Catch; easily slides into position.

#2. Hook; the effect is to catch opposing hook.

#3. Hook rod; space for opposing hook position.

#4. Extended hook; leading the hook in to the position when move back.

#5. Sleeve; To connect and hold on to the fish-tape or leader head

#6. Dowel; this is one way to lock the QUIK Catch on the head of fish-tape by pushing into the sleeve.

#7. Window; To release QUIK Catch from fish tape or leader head, press down on dowel through window.

#8. Entrance; easily push the fish-tape into the sleeve.

1. Design for characterization to catch each fish-tape or fish-tape leader when through in to the electrical conduit.

2. The material can be made of plastic, nylon or metal.

3. Attach to the head of a fish-tape and lead or similar tools.
